(19) United States
(12) Patent Application Publication
(10) Pub. No.: US 2019/0316743 A1
(43) Pub. Date: Oct. 17, 2019

(54) LIGHT STRING WITH MULTIPLE MOVABLE CLIPS

(71) Applicants: Vivian Planinsek, Rye, NY (US); Elizabeth Goodwin, Stamford, CT (US)

(72) Inventors: Vivian Planinsek, Rye, NY (US); Elizabeth Goodwin, Stamford, CT (US)

(21) Appl. No.: 16/345,344

(22) PCT Filed: Nov. 3, 2017
(86) PCT No.: PCT/US17/59989

§ 371 Date: Apr. 26, 2019

Related U.S. Application Data
(60) Provisional application No. 62/413,915, filed on Oct. 27, 2016.

(51) Int. Cl. F21S 4/10; A47G 33/10; F21V 21/088

(52) U.S. Cl. CPC F21S 4/10; F21W 2121/04; F21V 21/088; A47G 33/10

(57) ABSTRACT

The invention is directed to a string of lights including a plurality of moveable attaching means such as a spring-loaded alligator clip.

### RELATED APPLICATIONS

The present application claim priority from provisional application Ser. No. 62/413,915 filed Oct. 27, 20016.

### FIELD OF THE INVENTION

The present invention relates to broadly to lights and more particularly relates to a string of lights including at least two movable clips, a method of use, and a kit containing such apparatus.

### BACKGROUND OF THE INVENTION

Lights on strings for illuminating Christmas trees, outside landscaping, indoor doorways, windows, rooms and the like are known. The Christmas tree industry is a $1 billion annual industry in the United States alone and this figure does not include light strings or non tree related decorations. Consumers purchase both real trees and artificial trees each year. Consumers further purchase lights to decorate their Christmas trees as well as doorways, fireplace mantles and many other indoor and outdoor locations. Many of these annual purchases are because the user's previous year's light string is too tangled to handle the following year or too many of the individual bulbs have broken. Further, many string light owners are forced to throw out their light strings with the tree at the end of the season because they cannot remove the string of lights from the real tree after it dries up and closes its branches.

Each year millions of individuals decorate a Christmas tree for the holiday season. For many people, putting up the string of lights on a tree, whether a real or artificial tree, is the worst and most stressful step in decorating the tree. The string of lights must be evenly spaced on the tree once complete and there should be an equal placement of the string of lights along the trunk of the tree, again whether real or artificial, and on the outer portion of the branches so again the illumination once the string of lights are lit is evenly placed and atheistically pleasing to the viewer. The stress and arguments between couples, family members and friends in placing the string of lights on the tree, again whether a real tree or artificial tree, affects all negatively when decorating the tree.

Many people purchase a real Christmas tree for the holiday season which has added complications when using conventional string lights on the real tree. For purposes herein a “real tree” means a fir tree that either retains its roots with dirt included in the base to be replanted after the holiday season or more popularly a fir tree that has been cut and sold as a decorative Christmas tree. The real tree must be allowed to open up and “drink” water for at least a day or so before the real tree can be acclimated to the indoor area for decoration. Many individuals don't wait the allotted time and start to decorate while the tree is still in the closed position, meaning the branches are still packed together. In order to place strings of lights on the real tree the individual must constantly push up each individual branch in order to place the string of lights on the branches. Even if the individual waits the allotted time for the real tree to open up and the branches to open from the trunk the individual still has to move some branches in order to place the string of lights closer to the trunk. In both situations the individual suffers cuts and abrasions on the hands, arms and face from the branches which are inflicted from the branches themselves and the spiky pine needles. In some instances the individual may have an allergic reaction to the real tree and break out into hives. Further, the individual's hands are typically covered in pine tar which exacerbates the cuts, scrapes, hives and abrasions on the hands and arms. This process can be painful at the time of infliction and for days afterward. The pine tar may also ruin clothes of the individual depending on how far the individual has to lean into the real tree branches in order to place the string of lights sufficiently on the branches. As the individual leans further into the branches and pine needles it results in cuts, scrapes and abrasions which may occur on the face. Notably, the string of lights in this method is placed or resting on the branch and not secured by any means. In some instances the individual may try to loop the string of lights over a few chosen branches in order to secure the string of lights from moving, however, this complicates removable of the string of lights when the tree is to be discarded at the end of the season.

During the season the individual must sufficiently water the real tree so that it does not dry up. Even with constant watering the branches of the tree will lose buoyancy and begin to droop. As the branches droop the string of lights fall off the branch onto the next lower branch resulting in more lights on one part of the tree versus other parts which remain dark without any lights. This situation now requires that the individual stand in front of the real tree and reposition the string of lights, resulting in additional cuts and scrapes to the hands and arms as the pine needles are now drier and sharper. This method of repositioning must be repeated over and over as the string of lights fall.

At the end of the season the individual will remove all the ornaments, garland, tinsel and the strings of lights in order to have the real tree mulched by the local municipality. However, many times the string of lights is impossible to remove from various branches and the individual has to throw out the string of lights with the real tree making the tree not a mulching candidate. Instead the individual throws out perfectly good working lights and now the dead tree must be placed in the garbage instead of the mulching pile producing more landfill instead of being recycled.

A possible alternative to string lights is a full lit artificial Christmas tree or other decorative items such as a wall-mounted tree outline or other holiday decorations. However, even when using a pre-lit artificial Christmas tree after a few years the individual lights break and will not light up such that the user has to now purchase one more more strings of lights to place on the “pre-lit” Christmas tree or to wrap around the decorative piece. At the end of the season the user then packs up the Christmas tree with the additional string of lights remaining on the branches which may be damaged in storage that year and not work the next year necessitating another new purchase of string of lights and so every year the “pre-lit” artificial Christmas tree has more and more strings of light added.

Thus, a need exists for string lights which can be easily attached to tree branches or any other surface. A further need exists for string lights which can be easily attached to tree branches or any other surface with a moveable attaching means configured to move along the string of lights. Alternative methods of illuminating Christmas trees are known but these tend to be complicated or expensive and still do not prevent all or many of the disadvantages described above, particularly where the string of lights is used on a real tree as opposed to an artificial or fake tree. It is therefore an object of the present invention to provide an uncomplicated and inexpensive means of illuminating the exterior and interior of a Christmas tree in which the above problems, disadvantages, complications and physical harm are obviated. Notably current known attaching means on a string of lights are not moveable along the string of lights and therefore limited in use.

Accordingly, a need exists for a string of lights which reduces the occasion of pine tar, cuts and scrapes on the user's hands and arms when attaching the string of lights with moveable attaching means to the tree branches. Another need exists to secure a string of lights to the branch of a tree. There further remains a need in the art for a string of lights with moveable attaching means for attachment to any surface such as a fence, house gutter, bush and the like.

A current popular use of a string of lights are Edison lights in a backyard for decoration which also exhibit the problem of how to hang the string of lights without a connecting means. Tiny lights or twinkle lights are also used in non-Christmas season to outline trees or other yard features, as well as indoors in rooms such as a dorm room or child's room as decoration. A further need exists for a string of lights with a moveable attaching means to be used on any surface. Another need exists for a string of lights with moveable attaching means including decorative features such as various holiday motifs, college mascots and logos, princesses, animals and the any other decorative motif. There is a further need for a kit with a string of lights, replacement lights, and interchangeable decorative features for the attaching means. The present invention provides a solution for these needs and other needs.

The present invention has been made to solve the above problems occurring in the prior art and other needs in regard to a string of lights, methods of use and a kit for same.

### SUMMARY OF THE INVENTION

In one aspect, an apparatus is provided, which is adapted and configured to include a string of lights and at least two movable attaching means.

In another aspect, a kit for a string of lights is provided including an apparatus which is adapted and configured to include a string of lights and at least two movable attaching means, replacement lights and at least two decorative motifs for the attaching means.

### DESCRIPTION OF THE DRAWINGS

The above and other advantages of the present invention will become readily apparent with reference to the following detailed description when considered in conjunction with the accompanying drawings which are incorporated in and constitute part of this specification, are included to illustrate and provide a further understanding of the devices and related methods of the invention. Together with the description, the drawings serve to explain the principles of the invention, wherein:

FIG. 1 is a view of the inventive string of lights with at least two moveable attaching means.

FIG. 2 is a closer perspective view of an attaching means as shown in FIG. 1 in a closed position.

FIG. 3 is a perspective view of an attaching means s shown in FIG. 1 in an open position.

FIG. 4 is a side view of an attaching means as shown in FIG. 1 in a closed position.

FIG. 5 is a view of the inventive string of lights with a least two moveable attaching means in use on a tree branch.

FIG. 6 is a view of the inventive string of lights with a least two moveable attaching means in use on a tree.

FIG. 7 is a view of the inventive string of lights with at least two moveable attaching means in use on a tree branch near a tree trunk with the branch in an uplifted position.

FIG. 8 is a view of the inventive string of lights with at least two moveable attaching means in use on a tree branch near a tree trunk with the branch in a falling down position.

FIG. 9A is a front view of the attaching means with a decorative motif including a star with the attaching means in an open position.

FIG. 9B is a side view of the attaching means with a decorative motif including a star.

FIG. 10 is a perspective view of the attaching means with a decorative motif including a star of David with the attaching means in a closed position.

FIG. 11A is a front view of the attaching means with a decorative motif including a butterfly with the attaching means in an open position.

FIG. 11B is a side view of the attaching means with a decorative motif including a butterfly.

FIG. 12 is a perspective view of the attaching means with a decorative motif including a diamond shape and sparkles with the attaching means in a closed position.

FIG. 13A is a front view of the attaching means with a decorative motif including a soccer ball with the attaching means in a closed position.

FIG. 13B is a side view of the attaching means with a decorative motif including a soccer ball.

FIG. 14A is a front view of the attaching means with a decorative motif including a football with the attaching means in a closed position.

FIG. 14B is a side view of the attaching means with a decorative motif including a football.

### DETAILED DESCRIPTION OF THE INVENTION

Reference will now be made in detail to the present invention, examples of which are illustrated in the accompanying drawings.

In accordance with one aspect of the invention, an apparatus is disclosed which is a string of lights including at least two movable attaching means. The inventive apparatus of a string of lights with at least two moveable attaching means is provided which includes a string, a plurality of light sockets and lights, and at least two moveable attaching means. The attaching means may include any means to attach the string to an object and secure the string to the chosen object. In one embodiment if the invention, the moveable attaching means is located on the string between two lights on the string and thus is fixed only between the two lights and can move between such lights along the string for positioning and attaching of the inventive string of lights to a chosen object. Thus the individual user can chose where to attach the inventive string of lights to a chosen object by moving the attaching means to a chosen location and then activating the attaching means.

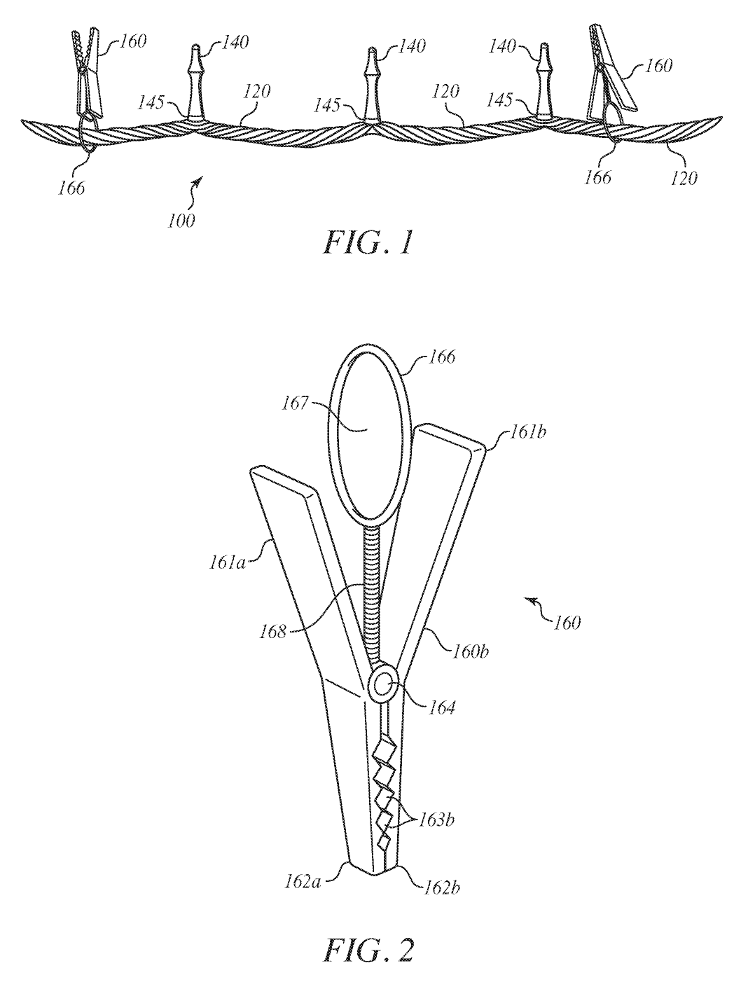

As seen in FIG. 1 in one embodiment of the present invention, the inventive string of lights 100 includes a string 120 and a plurality of lights 140 within light bulb holders 145. The inventive string of lights 100 includes a conventional household plug (not shown) at each end thereof which may be a male or female plug or most preferably contain both male and female features in combination on each of the plug. In the preferred embodiment where the end plugs each contain both a male and female features the inventive string of lights 100 can be joined to another inventive string of lights 100 and so on so as to connect additional or a series of inventive string of lights 100 together so as to decorate the tree or other chosen object. In other embodiments the power source of the lights 140 may be batteries or a solar charger or any other energy means. The lights 140 are spaced apart on the string 120 at intervals or spacing dependent on the total number of lights 140 on each string 120. The number of lights 140 on each string 120 may be in certain increment such as 25, 50, 100, 200, 500, 1000 or any other combination. The length of the string 120 may be any known length such as for instance 3-50 feet. The distance on the string 120 of each light 140 may be any chosen distance, for instance between 1-12 inches or any other imaginable distance on the length of the string 120.

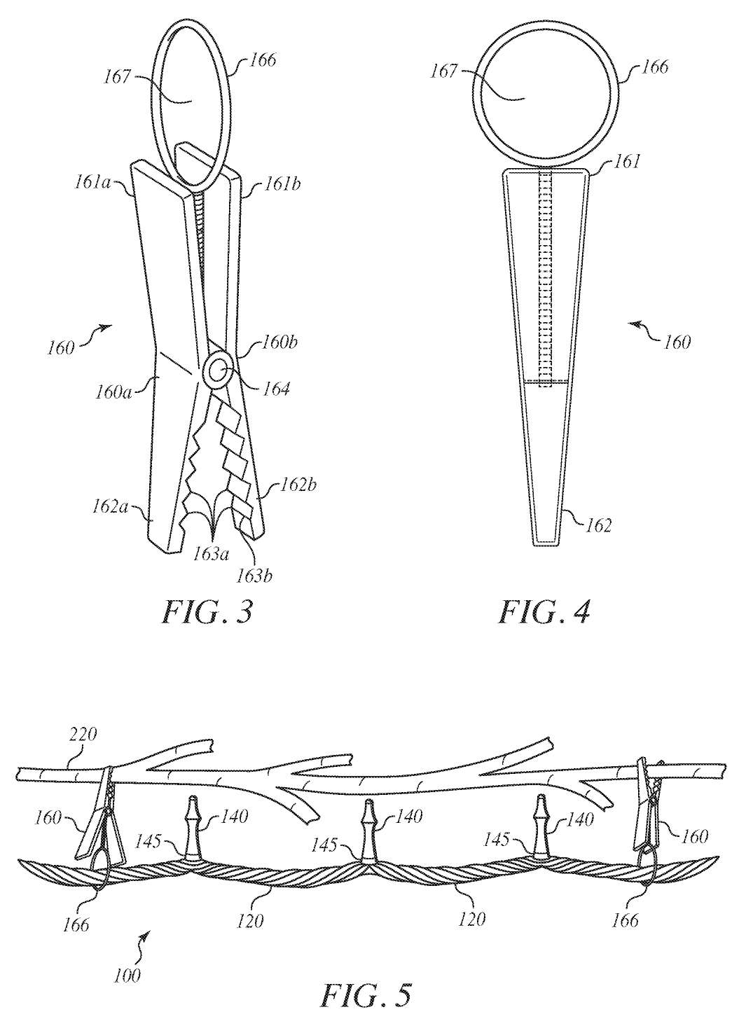

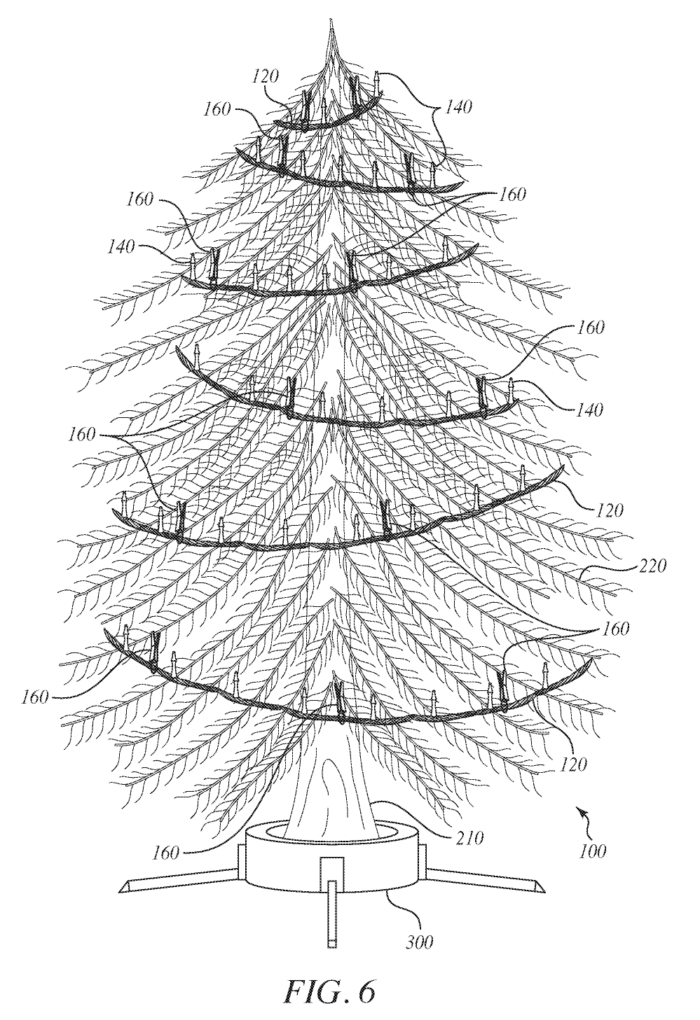

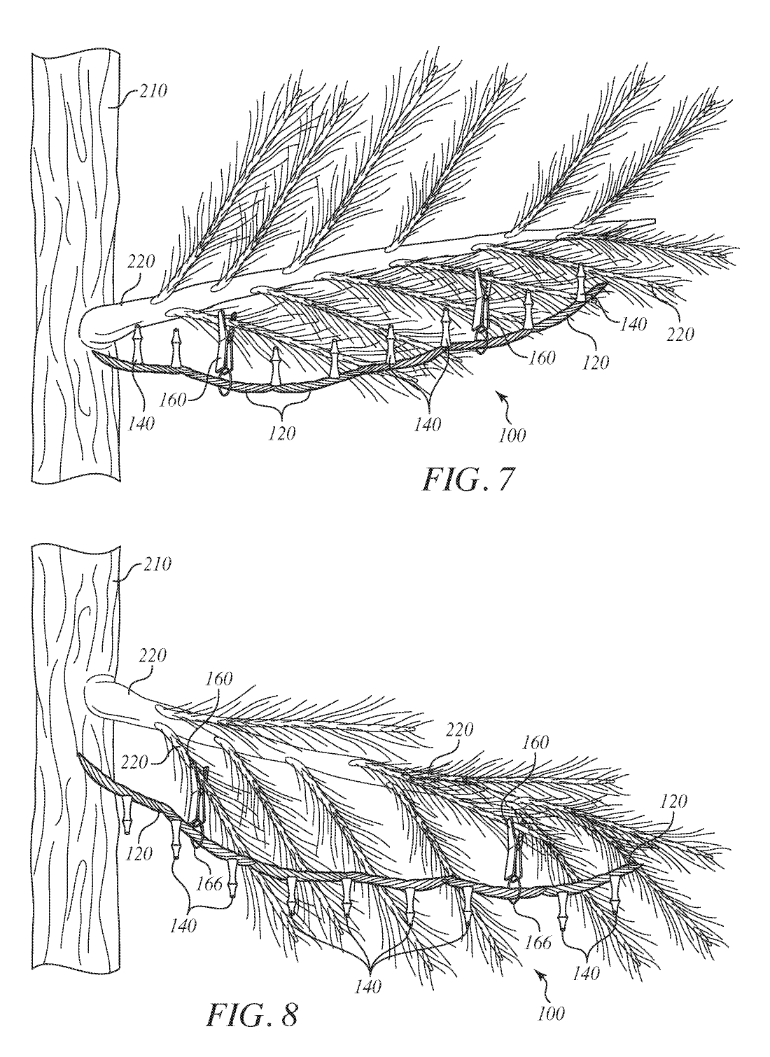

The attaching means 160 may be any means to attach the inventive string of lights 100 to a chosen objection. In one embodiment the attaching means 160 is an alligator spring clip as shown in FIGS. 2-4 and 9A-14B. The attaching means 160 as an alligator spring clip includes a pair of jaws 160a, 160b resembling an alligator's jaws. The pair of jaws 160a, 160b include a distal end 162a, 162b with the indentations configured like the teeth of the alligator 163a, 163b for attaching to the chosen object such as a tree branch 220 as show in FIGS. 5-8 when the attaching means 160 is in the closed position. The pair of jaws 160a, 160b further include a proximal end 161a, 161b which may be squeezed together by the user so as to activate the distal end 162a, 162b with the teeth of the alligator 163a, 163b from the closed position to the open position and then the user may place the open jaws 162a, 162b, 163a, 163b over the chosen object and release the proximal ends 161a, 161b so that the distal ends 162a, 162b with the teeth of the alligator 163a, 163b return to the closed position and thus is attached to the chosen object, such as a tree branch 220.

The pair of jaws 160a, 160b in this embodiment are joined by a spring loaded pivot pin 164. The attaching means also includes a means to attach to the string such as in one embodiment a ring 166. The ring 166 has an aperture 167 with a diameter which is larger than the diameter of the string 120 so that the ring 166 can move along the string 120 as shown in FIGS. 1 and 5-8. Thus the inner circumference of the ring is larger than the outer circumference of the string. The string of lights 100 should include a plurality of attaching means such as one attaching means 160 every other light, to one attaching means 160 every twenty lights 140 or longer ranges. It is preferred that each attaching means 160 is placed on the string 120 once every 4-6 lights 140. Thus the inventive string of lights 100 includes at least two moveable attaching means 160. The ring 167 may be attached to the spring loaded pivot pin 164 by another spring 168 or any other connecting means.

While the embodiment above for the attaching means 160 is a spring loaded alligator clip other attaching means may be used such as Babcock graspers, alligator graspers, French graspers, Reddick graspers, spoon cup graspers, right angle graspers, clamps, claws, jaws and the like. Other attaching means could be employed such as clasps, graspers, pins, hooks Velcro, snaps and the like. The attaching means 160 should have some leverage and expansion in order to attach to the chosen object and to secure the string of lights 100 to such object.

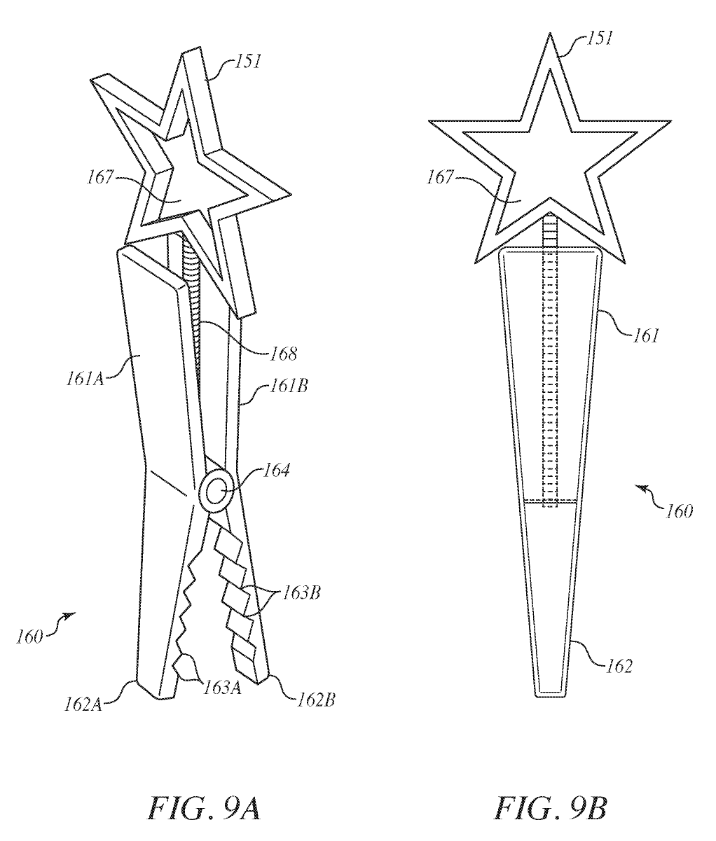

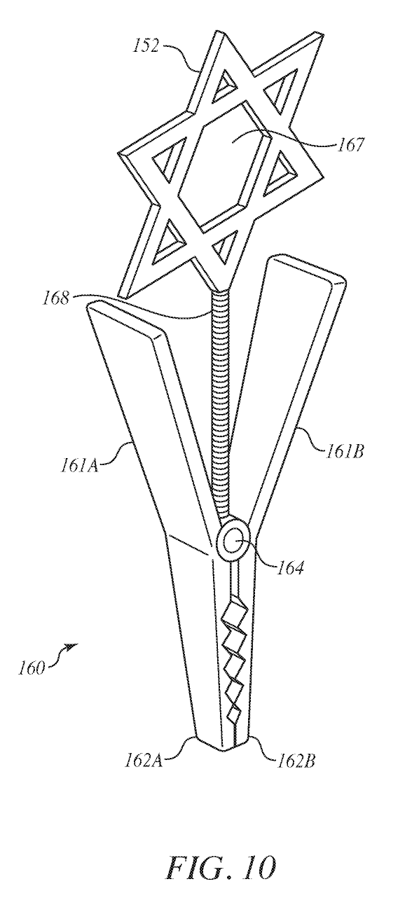

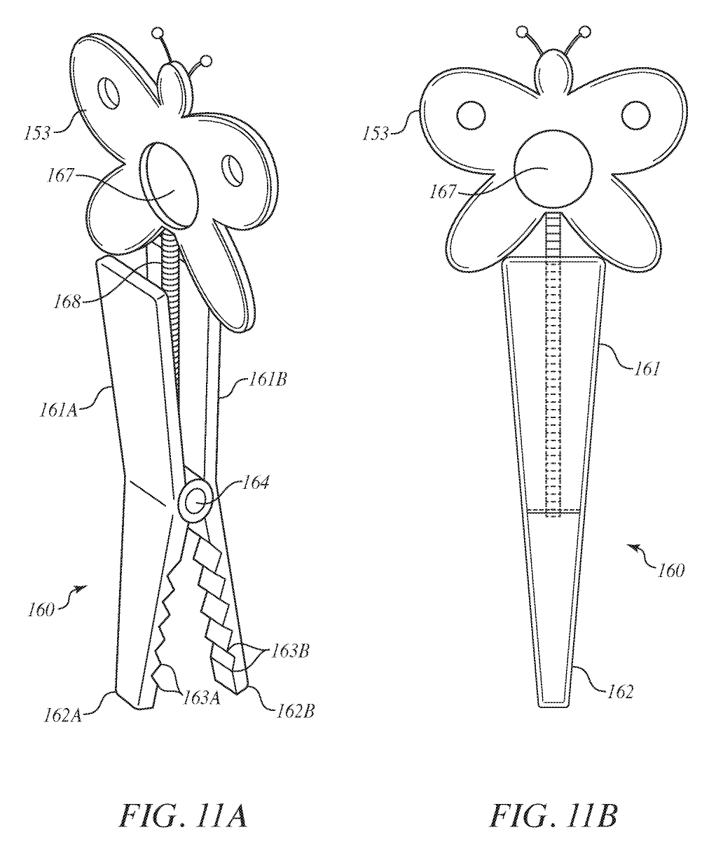

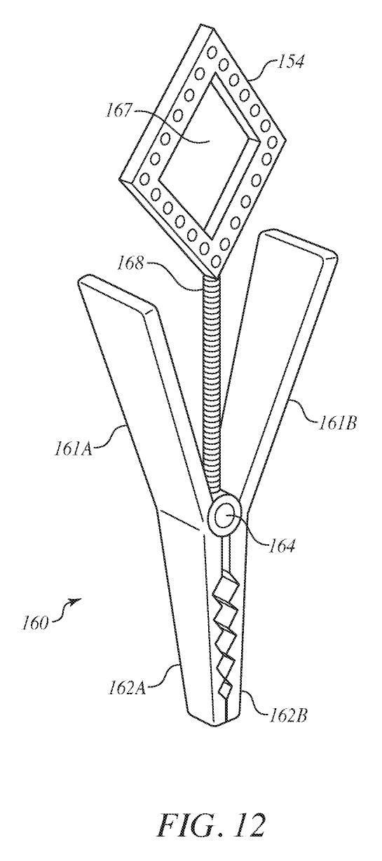

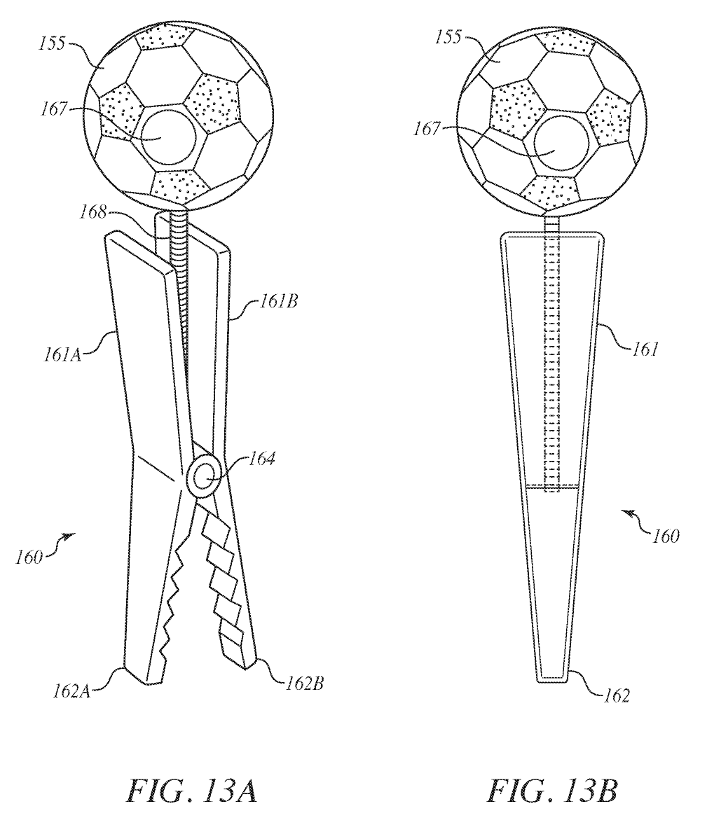

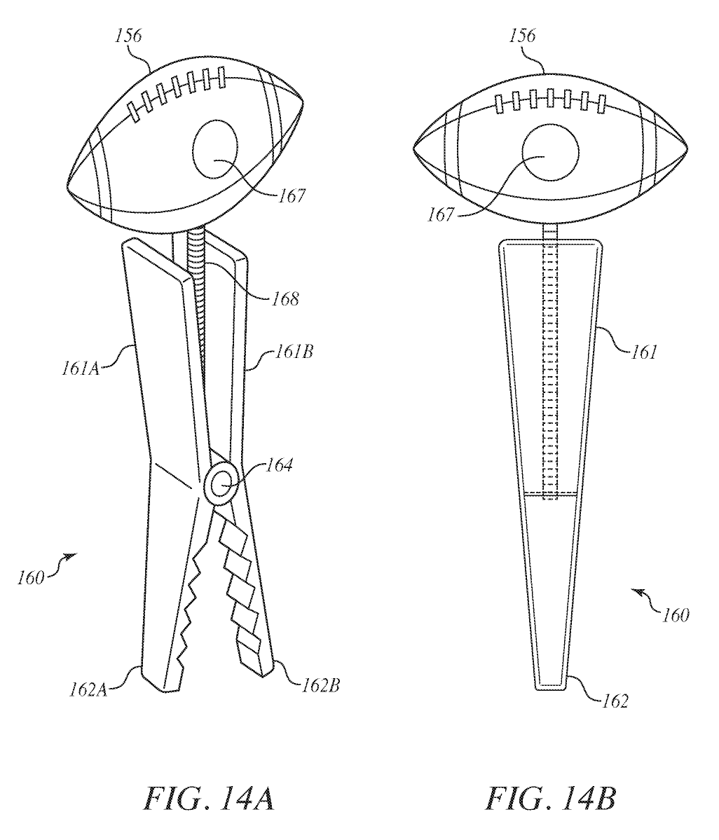

In other embodiments of the present invention the ring 166 may be any geometric shape or a decorative motif as shown in FIGS. 9A through 14B. This moveable connector is in lieu of a ring but has an aperture 167 with a diameter larger than the diameter of the string 120 so that the attaching means 160 can move on the string 120. For example, the star moveable connector 151 as shown in FIGS. 9A and 9B has a center opening 167, or aperture, which is larger than the diameter of the string 120. The Star of David moveable connector 152 as shown in FIG. 10 also has a center opening 167, or aperture, that is larger than the diameter of the string 120. Other holiday motifs and shapes may be used in lieu of a ring 166 as long as the center aperture 167 is larger than the diameter of the string 120 such that the attaching means 160 is thus moveable along the string 120 when in use. Other decorative motif are shown in FIGS. 11A through 14 such as without limitation a butterfly moveable connector 153 (FIGS. 11A and 11B), diamond geometric shape with sparkles moveable connector 154 (FIGS. 12A and 12B), a soccer ball moveable connector 155 (FIGS. 13A and 13B) and a football moveable connector 156 (FIGS. 14A and 14B) though any other decorative motif or feature may be employed. Each of these possible decorative motifs has an aperture 167 configured to be larger than the diameter of the string 120 to allow the attaching means 160 to be moveable along the string 120. In one embodiment of the present invention the inventive string of lights 100 having multiple moveable attaching means includes a decorative portion which moves along the string 120, such as a sports theme and in such embodiment the inventive string of lights 100 may be used to decorate a room, either indoors or outdoors, to coordinate with the theme of the moveable connector. For instance, a user at a birthday party may employ an inventive string of lights 100 having multiple moveable attaching means 160 which include a birthday cake moveable connector (not shown) or birthday hat moveable connector (not shown), each having an aperture 167 with a diameter larger than the diameter of the string 120, as decorative lighting for the party. In another embodiment, an inventive string of lights 100 including the moveable connectors of a soccer ball 155 could be used to provide decorative lighting for a child's room attaching to a bookcase, shelves, curtain rods, or any other means of connecting within the child's room. Any geometric shape or design or motif can be used for the moveable connector portion of the attaching means 160.

The decorative movable connector, such as butterfly connector 153, may be connected to the spring loaded pivot pin 164 by another spring 168 or any other connecting means. Thus the attaching means 160 can move along the string 120 as the object to which it is secured, such as a tree 200, moves, such as a tree branch 220. Instead of a spring 168 the connecting means can be any other flexible members capable of movement. In use, the spring 168 can move as the tree branch 220 move and dry, while keeping the inventive string of lights 100 secure on the drying tree branch 220 and preventing the string of lights 100 from falling off of the moving, drying and dropping tree branch 220.

The string 120 can be a wire or plurality of wires (not shown) wrapped in plastic covering which covering may be colored green to blend into a tree, or colored white or black or any color. The lights 140 may be conventional size, mini-lights or larger lights, and may be LED, incandescent or any other known light type. The lights 140 may be clear or white, or may be colored in one color such as for instance and by way of example only red, or may be multi-colored.

The attaching means 160 may be comprised of any material such as metal, plastic, wood or the like. It is preferred the attaching means 160 is a plastic material for safety as it moves along a string 120 in between lights 140 which are connected to a power source. The attaching means 160 may optionally include hinge or other manner in which to remove the ring 166 and the attaching means 160 from the string 120 in the event the ring 166 breaks or the jaws 160a, 160b break or the pivot breaks 164. The ring 166 could be shaped with a latch or other means to connect the ring 166 to the spring 168. In another embodiment the ring 166 could be shaped like a key ring having a circular ring that is split at one point to provide a gap of sufficient width to pass a portion of the spring 168 to connect to the ring 166. In both of these embodiments and any other embodiment with a way to remove the ring 166 from the attaching means 160, the purposes is to provide a means to replace the ring 166 o any other portion of the attaching mean 160 if a part breaks or is unusable.

In use the inventive string of lights 100 is attached to a chosen object such as a tree branch by positioning the moveable attaching means 160 at a location for attachment and then activating the moveable attaching means 160. If a Christmas tree is the chosen object, whether a real tree or an artificial tree, the individual user may illuminate the tree 200 by positioning and attaching the inventive string of lights 100 on tree branches 220 via the attaching means 160 decorated on, the inside along the trunk 240 and the outside by simply winding the light string around the tree in the conventional manner and at the intervals dictated by the distance between each branch. The inventive string of lights 100 is thus secured to the tree branches 220 by the attaching means 160. The inventive string of lights 100 is then plugged into an electrical source and the lights 140 are illuminated. At any time the attaching means 160 can be activated again and the attaching means moved along the tree branch 220 to reposition the inventive string of lights 100 or to remove the entire string of lights 100 when the holiday is over and the Christmas tree either stored if artificial, or replanted or mulched if a real tree.

It should be noted that although the apparatus of the present invention is advantageous for illuminating a Christmas tree (real or artificial) it can advantageously be used on fences, household gutters, pipes, shrubbery, bushes, windows, curtain rods, any surface indoors or outdoors, and the like. The lights 140 may be of any configuration such as Edison lights which can be hung in a backyard or patio for decorative purposes during the summer months via the multiple moveable attaching means. In this instance the inventive light of string 100 including Edison style lights 140 would be attached to an outdoor patio or deck or backyard location and then removed in the autumn, or left attached for the winter months as additional seasonal lighting. In another embodiment the inventive string of lights 100 could be used indoor in a room for decoration and the multiple moveable attaching means 160 could be attached to a window sill or curtain rods or a shelf or book case or any surface capable of attachment by the multiple moveable attaching means 160.

A kit including the inventive string of lights 100 may further include replacement light bulbs, replacement attaching means, 160, replacement rings 166, and interchangeable attaching means with different decorative means such as varying sports themes.

Thus, the inventive string of lights 100 provides an uncomplicated and inexpensive means of illuminating the exterior and interior of a Christmas tree in which the above problems, disadvantages, complications and physical harm are reduced or eliminated. It also provides an easy way to decorate indoors and outdoors with lights not limited to Christmas decorations.

The inventive string of lights 100 reduces stress and arguments between couples, family members and friends in placing the string of lights on the Christmas tree, whether a real tree or artificial tree, as the multiple moveable attaching means 160 are more easily placed and attached to the tree branches. The inventive string of lights 100 can be moved and relocated over and over by the user without further complication. Additionally, the inventive string of lights 100 is secured to the Christmas tree branch via the multiple moveable attaching means 160. The inventive string of lights 100 may be secured and easily attached to other objects such as fences, wood, pipes, bushes, shrubs, shelves, curtain rods and any other objects.

The inventive string of lights 100 reduces the occasion of pine tar, hives, cuts and scrapes on the user's hands and arms when attaching the string of lights 100 with moveable attaching means 160 to the tree branches 220. The inventive string of lights further allows for an easier, less stressful, and more aesthetically pleasing and balanced application of lights on the Christmas tree or other chosen object. Additionally, the inventive string of lights is easy to remove or to relocate on the chosen object via the attaching means compared to pulling a strand of lights off of a drying Christmas tree for instance. Thus, using the inventive string of lights reduces the mess and stress of taking down the Christmas tree or other chosen object which was previously illuminated with the lights. Further, use of the inventive string of fights may be more cost effective as the string of lights is not thrown out at the end of the holiday season while still on the real Christmas tree. The easier removal and relocation of the inventive string of lights also cuts down and reduces the likelihood of the string of lights being tangled on an object when looped around the object, such as tree branches or bushes or fences, and the like. When used outdoors, the attaching means secures the inventive string of lights to the object and thus reduces the need to relocate the string of lights due to wind, animals and the like. The multiple moveable attaching means at the same time moves along with the wind, animals and the like thus reducing the potential for broken lights and wires.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

The invention has been described in terms of embodiments thereof, but is more broadly applicable as will be understood by those skilled in the art.

We claim:

1. An apparatus for illuminating a Christmas tree comprising:
(a) a string including a power source, wire, light bulb connector, and a plurality of light bulbs; and
(b) at least two attaching means configured to move along an outer circumference of the wire and to attach to a branch of the Christmas tree.

2. The apparatus of claim 1 wherein the attaching means is selected from the group of clips, clasps, graspers, pins, hooks and the like.

3. The apparatus of claim 1 wherein the attaching means is a grasper selected from the group of alligator clips, Babcock clips, French graspers, Reddick graspers, spoon cup graspers, right angle graspers, and the like.

4. The apparatus of claim 1 wherein the attaching means is an alligator spring-loaded clip having a set of jaws.

5. The apparatus of claim 1 wherein the attaching means further includes a moveable connector configured to move along an outer circumference of the wire wherein the moveable connector is a geometric shape having an aperture with an inner circumference larger than the outer circumference of the wire.

6. The apparatus of claim 5 wherein the moveable connector is a circle, square, diamond, rectangle, sphere or other geometric shape.

7. The apparatus of claim 5 wherein the moveable connector is a decorative piece including an aperture.

8. The apparatus of claim 5 wherein the moveable connector is connected to the pair of jaws by a flexible member.

9. The apparatus of claim 8 wherein the flexible member is a spring.

10. An apparatus for illuminating comprising;
(a) a string including a power source, a wire, a plurality of light bulb connectors, and a plurality of light bulbs wherein the lights are in a spaced-apart distance; and
(b) at least two attaching means configured to move along an outer circumference of the wire and each attaching means is located within two spaced-apart lights on the string.

11. The apparatus of claim 10 wherein the attaching means is selected from the group of clips, clasps, graspers, pins, hooks and the like.

12. The apparatus of claim 10 wherein the attaching means is a grasper selected from the group of alligator clips, Babcock clips, French graspers, Reddick graspers, spoon cup graspers, right angle graspers, and the like.

13. The apparatus of claim 10 wherein the attaching means is an alligator spring-loaded clip having a set of jaws.

14. The apparatus of claim 10 wherein the attaching means further includes a moveable connector configured to move along an outer circumference of the wire wherein the moveable connector is a geometric shape having an aperture with an inner circumference larger than the outer circumference of the wire.

15. The apparatus of claim 14 wherein the moveable connector is a circle, square, diamond, rectangle, sphere or other geometric shape.

16. The apparatus of claim 14 wherein the moveable connector is a decorative piece including an aperture.

17. The apparatus of claim 14 wherein the moveable connector is connected to the pair of jaws by a flexible member.

18. The apparatus of claim 17 wherein the flexible member is a spring.
